(19) United States
(12) Patent Application Publication
(10) Pub. No.: US 2015/0371100 A1
(43) Pub. Date: Dec. 24, 2015

(54) CHARACTER RECOGNITION METHOD AND SYSTEM USING DIGIT SEGMENTATION AND RECOMBINATION

(71) Applicant: Xerox Corporation, Norwalk, CT (US)

(72) Inventors: Safwan R Wshah, Webster, NY (US); Michael R. Campanelli, Webster, NY (US)

(21) Appl. No.: 14/312,177

(22) Filed: Jun. 23, 2014

(51) Int. Cl. G06K 9/18; G06K 9/52; G06K 9/00; G06T 7/00

(52) U.S. Cl. CPC G06K 9/18; G06T 7/0079; G06K 9/52; G06K 9/00402

(57) ABSTRACT

Method and systems are provided for recognizing characters in an original image. The images received in the system as a set of pixels representing the original image as a character skeleton and a chaincore representation thereof. A skeleton intersection points are identified using a basis for determining a cutting points in the chaincore contours compared to the cutting points are then used to define cutting lines for segleg the original image into distinct segments. The segments are analyzed with respect to their geometric properties individually and relative to adjacent to other segments for determination that select ones of the segments may be combined wherein the combination is expected to have a high probability of conformance to a likely a digit or character. Verification that the combined string is a recognizable digit or character is accomplished using a convolutional neural network digit recognizer.

### FIELD

The subject embodiments relate to the field of image processing, and more particularly, the processing of scanned images for the recognition of numeric digits or characters therein.

### BACKGROUND

The automatic processing of machine printed and handwritten documents for character or digit recognition is a common task. Large numbers of hardcopy forms are sent to recognition processors every day to be prepped for electronic scanning, optical character recognition (OCR) and image character recognition (ICR) to capture and interpret the data. Large amounts of the scanned data comprises digits such as street numbers, zip codes, telephone numbers, social security numbers, charges, medical codes, ID's, etc.

The recognition of handwritten digits strings is still a common problem as such strings include variable and overlapping character lines. One of the main challenges of segmentation techniques that read a string of digits for segmenting them into isolated digits is a lack of context. In many cases one does not know the intended number of digits in the string to be segmented and thus the segmented optimal boundaries between them are unknown.

There are two main classes of segmentation algorithms: segmentation recognition in which the segmentation technique provides a single sequence hypothesis where each sub-sequence should contain an isolated digit. The other class is recognition-based, in which more than one sequence hypothesis is considered and assessed through the recognition process. In general the segmentation recognition class is faster but recognition based gives better and more reliable results.

The main drawbacks of most of these algorithms are the large number of cuts, which must be evaluated by the recognition algorithm, and the number of heuristics that must be set. Moreover, the recognition module has to discriminate different patterns, such as fragments, isolated digits, and connected digits.

Even good performance of the recognition-based approach can suffer from the dependency on the digit recognizer to segment the string, thus a better and faster digit classifier helps segmentation process performance. The main challenge of the digit recognizer is the high variability of the digit data that has been over-segmented due to the large number of cuts.

There is thus a need for improved digit and character segmentation techniques which can relieve over-segmenting of an original image by combining segments to thereby maintain only optimum cuts for the recognition analysis.

### SUMMARY

Systems and methods are proposed to segment characters or digits based on the image skeleton and chaincode. The segmentation algorithm produces a list of segments hypotheses; the list is then reduced by applying another algorithm that combines the segments based on selected geometrical information. The digit string is then recognized and verified by a convolutional neural network digit recognizer.

A character recognition system for identifying an image as a set of characters is provided. The system includes a processor for receiving an image comprising a set of pixels, and representing the image as a character skeleton and a chaincode thereof. The processor further finds intersection and cutting points in the skeleton and chaincode representation and then cuts the skeleton and chaincode representation along adjacent cutting points into a plurality of segments. The processor then combines selected ones of the segments into a string of segments having a high probability of conforming to a likely character. The likely character is then verified with a convolutional neural network recognizer as a recognized character or digit.

The combining is affected by rules set in a combining algorithm relative to the geometrics of the segments and the original image.

### BRIEF DESCRIPTION OF THE DRAWINGS

FIG. 1 is flow chart of the steps employed in the subject embodiments;

FIGS. 2(a), 2(b) and 2(c) illustrate the analytical evolution of a digit string during segmentation and combining; and

FIGS. 3(a) and 3(b) are illustrations of an intersection point and a distance map used to find cutting points for segmentation.

### DETAILED DESCRIPTION

The goal of the subject embodiments is to segment and recognize touching digits or characters that typically occur in documents or the likes, especially when they are hand-drawn. One of the main challenges of a segmentation technique that reads a string of digits and segments them into isolated digits is the lack of context, i.e., one usually does not know the number of the digits in the string and thus the optimal boundary between them is unknown.

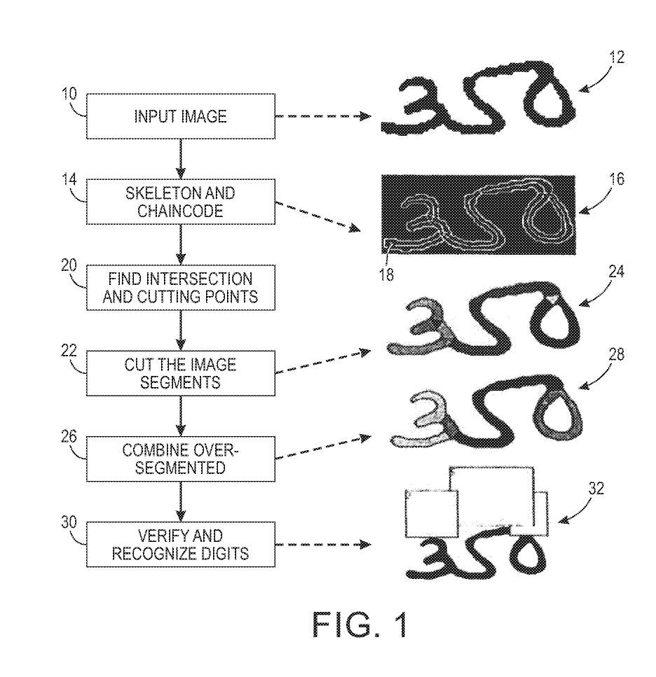

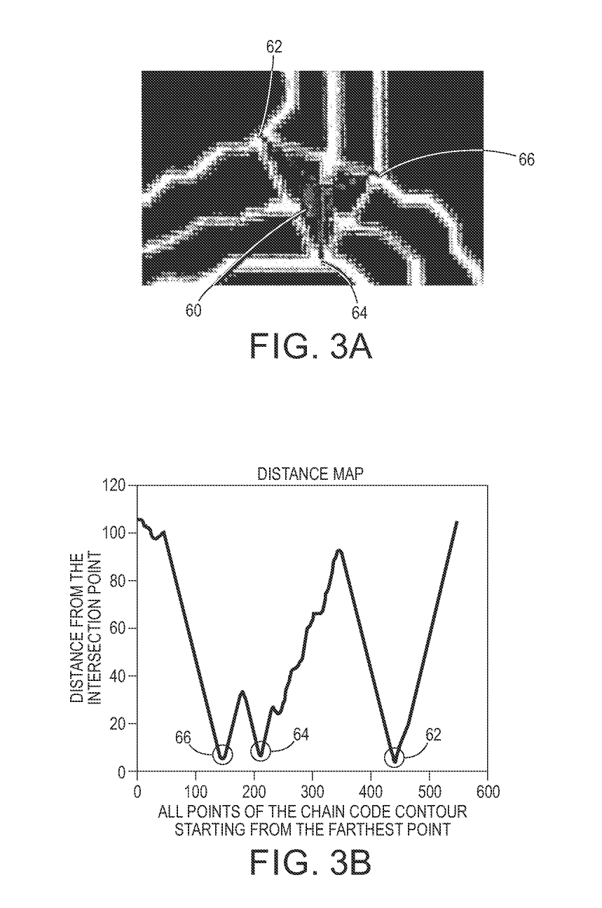

With particular reference to FIG. 1, the subject embodiments first involve inputting in original image comprising a character representation such as a string of digits that overlap and connect in some areas such as in illustrated as the “350” 12 shown in FIG. 1 in to a processing system (not known). The original image 12 is converted and represented as a plurality of pixels, in this case, black on a white background, in accordance with conventional scanning imaging or printing techniques although any image writing printing in display format is processable with the subject system. The data comprising the illustrated representations is received in a processor (not shown) which may either be a dedicated processing system or a cloud-based server implemented by a network of computers (or, more generally, an electronic data processing devices) operatively interconnected via a Local Area Network (LAN, wire and/or wireless) the Internet or so forth (i.e., a processor may be a distributed server). In some configurations, computers and/or processing time on individual computers may be allocated to or de-allocated from such a process automatically or on an ad hoc basis to accommodate changes in processing load. The first analytical processing of the original image is to convert the image 12 into a skeleton and a chaincode representation 14 such as is illustrated by representation 16. By skeleton is meant minimizing the image line width dimension to a single pixel that forms a central line 18 effectively extending through the outer contour of the lines of the original image. The chaincode 20 is seen as just the outer contour of the original image 12 which is similarly reduced to a line of single pixel width to form a representation of the entire outer boundary of the image 12. The skeleton and chaincode 16 are then analyzed to obtain dimensional relationships between identifiable intersection points 20 and cutting points, as will be explained in more detail with reference to FIGS. 3(a) and (b). The image is then segmented 22 by cutting it into a plurality of image segments along cut lines defined by the cutting points. The segments are illustrated in image 24 as a variety of different colors wherein each color of the image 24 accordingly represents a single segment. Image 24 is clearly over-segmented in that a likely digit such as the “3” shown in image 24 is represented by four segments. In order to better facilitate the recognition of the “3” some segments are combined 26 in accordance with a combining algorithm, discussed more in detail below. Image 28 shows that after combination, the number of segments to be analyzed for digit recognition is reduced so that the connected strings have a high probability of conformance to an easier to recognize numeric digit. Lastly, the subject embodiments verify and recognize 30 the image representation 28 to be a recognizable character or digit. Such recognition is effected through a convolutional neural network recognizer, as will be discussed below, but the end result is that the image first scanned in as image 12 is actually recognized as the numeric number “350” 32.

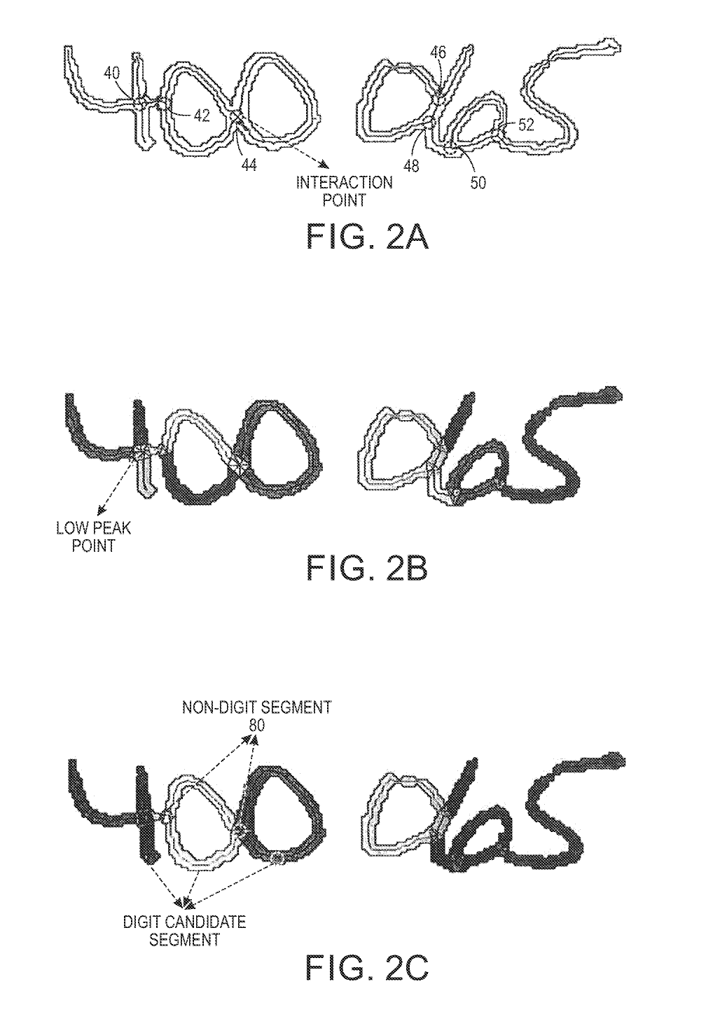

With reference to FIGS. 2 and 3, the segmentation process is explained in more detail. FIG. 2(a) shows a plurality of intersection points in both the skeleton and chaincode representations of a digit string for the number “400” and “065”. The “400” has three intersection points 40, 42, 44, while the “065” string has four intersection points 46, 48, 50, 52. An intersection point is defined as a point in the image where the skeleton has an intersection with another line. FIG. 2(b) shows that the intersection points are then analyzed for the identification of cutting points used for forming cut lines in the segmenting step. In FIG. 3(a), an intersection point 60 is identified, then corresponding chaincode cutting points for the segment are determined based on a geometric relationship to the intersection point 60. A distance map, FIG. 3(b), is built identifying the geometric distance between the intersection point and all ambient chaincode contour points, starting from the farthest chain code point. The two lowest peaks in the distant map are then identified and saved in an “all-peak-list” as end points of a certain cut line during the segmenting. FIG. 3(b) illustrates three lower peaks 62, 64, 66 that are separated by a predetermined distance threshold. More than one cutting point can be identified per intersection point and also saved in a “finalpeaklist”. Initially though, the finalpeaklist will only have a single pair that is the lowest peak's pair separated by the distance threshold. The following equation

$${d}_{f .4} < \frac{( {d}_{f .1} + {d}_{f .2} + {d}_{f .3} )}{2} \qquad 1.1$$

Where d_{i,j}: Distance from the peak(i) point to the intersection point.
is applied to find if a third or fourth peak can be applied to the finalpeaklist. The distance between any third or fourth peak and the peaks already in the finalpeaklist has to be less than the distance of the threshold, and if so, a third or fourth peak point can be added to the final peak list. Cut lines are defined by drawing a line from one peak point to the closest first and second adjacent peak points in the same list. With reference to FIG. 3(a), three peak points are shown 62, 64, 66 so three drawn lines forming the cutting lines are determined to form the triangle in FIG. 3(a). If a fourth peak point is applied, the lines can form a four-sided box, such as is shown in the “400” of FIG. 2(b). The image segments outside of the drawn lines are distinguished by different colors as distinct segments. Such segmenting can be effected using connected component analysis. The “4” in FIG. 2(b) is now segmented into four different colorized segments as is the 6 in the “065”.

It can be appreciated that the images in FIG. 2(b) have been over-segmentized and so the intended combination of certain segments is next performed. A second algorithm defines the process of the combining. The algorithm has as the inputs a segmented image list, a segmented images dimension list, and a combining threshold. The segmented images list and the segmented images dimension list are sorted according to segment area. For each segment in a segment list: (i) that if it is a same segment, then continue without combining (ii) if the segment is larger than the specified combining threshold, then continue without combining (iii) if the two adjacent segments share a specified percent (combining threshold) then combine those segments. If the segment dimensions are relatively big, then vertically split the image into two equal segments. Each segment in the list is marked as a digit candidate or non-digit-candidate. FIG. 2(c) shows non-digit segments and digit-candid segments 82.

The combining algorithms not only combines the segments but also marks segments to digit or non-digit candidates, thus instead of examining all hypothesis in a segmented image, only the digit candidate with few hypotheses around it are examined to find a likely character/digit.

The first algorithm for identifying the cutting lines can be summarized as:

Algorithm 1

INPUT: Skeleton image segments, chain code segments, distance
threshold.
1. For each segment in the skeleton image:
a. For each intersection point in the segment:

| | |
|---|---|
| i. | Find the corresponding chain code contour for the current |
| | skeleton segment. |
| ii. | Build the distance map (between the intersection point and all |
| | chain code contour points) as shown in Figure 3(c) starting from |
| | the farthest chain code point. |
| iii. | Find all lower peaks and save them in allpeaklist. |
| iv. | In the peaklist Find the lowest peaks pair that is separated by |
| | distance threshold and save them in finalpeaklist. |
| v. | Apply equation 1.1, to find if the third and fourth peak applied, |
| | the distance between the peaks has to be less than distance |
| | threshold, if the third or fourth peak points applied add them to |
| | finalpeaklist. |
| vi. | Draw lines form each peak point in the finalpeaklist to the |
| | closest two peak point in the same list. |

b. Colorize the new segments using connected component analysis.

The second algorithm for combining segments can be summarized as:

Algorithm 2

INPUT: segmented images list, segmented images dimension list,
combine threshold.
Sort the image list and images dimension list according to segment area.
1. For each segment in the images list:
a. For each segment in the images list:

| | |
|---|---|
| i. | If same segment then continue. |
| ii. | If the segment width to height is larger than specified |
| | threshold then continue. |
| iii. | If the two segments share specified percent (combine |
| | threshold) of horizontal dimensions then combine the |
| | segments. |

2. For each segment in the images list:
If the segment dimensions are big then vertically split the image into two
equal segments.
3. For each segment in the images list
Mark each segment based on its dimensions to digit candidate or non-digit
candidate.

See http://cs.stanford.edu/-zhenghao/papers/LeNciiamChenChiaKohN g2010.pdf and http://vann.lecun.com/exdb/publis/pdf/lecun-01a.pdf for additional information on methods and samples for convolutional neural network recognizers, which is hereby incorporated by reference.

The disclosed processing system may include various sub-systems and constituent modules that are suitably embodied by an electronic data processing device such as a computer.

Moreover, the disclosed processing techniques may be embodied as a non-transistory storage medium storing instruction that are readable by and executable by the computer or other electronic data processing device to perform the disclosed document processing techniques. The non-transitory storage medium may, for example includes a hard disk drive or other magnetic storage medium, a flash memory, random access memory (RAM), read-only memory (ROM), or other electronic memory medium, or an optical disk or other optical storage medium, or so forth, or various combinations thereof.

It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art which are also intended to be encompassed by the following claims.

What is claimed is:

1. A character recognition system for identifying an image as a set of characters including:
a processor
for receiving an image comprising a set of pixels and for representing the image as a character skeleton and a chain code representation thereof;
for finding an intersection and a cutting point in the skeleton and chain code representation;
for cutting the skeleton and chain code representation at the cutting point into a plurality of segments; and
for combining selected ones of the plurality of segments into a string of segments having a high probability of conformance to a likely character.

2. The system of claim 1 wherein the processor further verifies that the likely character conforms to a recognized character.

3. The system of claim 1 wherein the processor comprises the finding of the intersection point by building a distance map between a contour of the chain code representation and a selected skeleton segment of the character skeleton.

4. The system of claim 3 wherein the processor comprises the finding of the intersection point by identifying a set of lowest peaks in the distance map separated by a predetermined threshold.

5. The system of claim 4 wherein the processor for the cutting of the skeleton and chain code representation includes forming a line between adjacent closest ones of the lowest peaks to define cut lines segregating the image into the plurality of segments.

6. The system of claim 5 wherein the processor for the cutting of the skeleton and chain code representation includes colorizing the plurality of segments using connected component analysis.

7. The system of claim 1 wherein the processor for the combining selected ones of the plurality of segments includes the combining based on predetermined factors including at least one of segment continuation, segment width to height relationship, shared horizontal dimension between adjacent segments, a relative segment dimension to image dimension and a relative segment dimension to digit/non-digit candidate dimension.

8. The system of claim 1 wherein the processor for the combining selected ones of the pluralities of segments includes geometrical feature analysis in accordance with pre-selected standards.

9. The system of claim 1 wherein the image includes printed or hand-written documents.

10. The system of claim 10 wherein the documents include overlapping adjacent characters.

11. A method for recognizing digits in an original image comprising:
a) receiving the original image including a set of pixels representing the image as a digit skeleton and a chain code representation thereof;
b) finding an intersection point and a cutting point in the skeleton and chain code representation;
c) cutting the skeleton and chain code representation into a plurality of segments at lines defined by the cutting point;
d) combining selected ones of the plurality of segments with a string of segments having a high probability of conformance to a likely digit; and
e) verifying the digit;

12. The method of claim 11 further includes verifying the likely digit with a convolutional neural network recognizer.

13. The method of claim 11 wherein the finding of the intersection point is based on intersecting lines of the digit skeleton.

14. The method of claim 13, wherein the finding of the cutting point concludes determining a geometric relationship between the intersection point and the cutting point.

15. The method of claim 14, wherein the determining of the geometric relationship includes forming a distance map of chaincore contour points relative to the intersection point.

16. The method of claim 15, wherein the cutting point is a low peak point of the distance map.

17. The method of claim 11, wherein the combining of the segments is in conformance with an algorithm including:
Algorithm 2
INPUT: segmented images list, segmented images dimension list,
combine threshold.
Sort the image list and images dimension list according to segment area.
1. For each segment in the images list:
a. For each segment in the images list:

| | |
|---|---|
| iv. | If same segment then continue. |
| v. | If the segment width to height is larger than specified |
| | threshold then continue. |
| vi. | If the two segments share specified percent (combine |
| | threshold) of horizontal dimensions then combine the |
| | segments. |

2. For each segment in the images list:
If the segment dimensions are big then vertically split the image into two
equal segments.
3. For each segment in the images list
Mark each segment based on its dimensions to digit candidate or non-digit
candidate.
